(19) United States
(12) Patent Application Publication
(10) Pub. No.: US 2017/0069146 A1
(43) Pub. Date: Mar. 9, 2017

(54) VEHICLE DIAGNOSTIC SYSTEMS AND METHODS THEREFOR

(71) Applicant: Auto E-Diagnostics Services, Inc., Walnut Creek, CA (US)

(72) Inventors: Chin-Yang Sun, Austin, TX (US); Chih-Hong Sun, Taipei City (TW)

(21) Appl. No.: 15/268,529

(22) Filed: Sep. 16, 2016

Related U.S. Application Data
(63) Continuation-in-part of application No. 14/846,531, filed on Sep. 4, 2015.
Application No. 14/846,531 is a continuation of application No. 12/568,677, filed on Sep. 29, 2009, now abandoned.
(60) Provisional application No. 62/220,865, filed on Sep. 18, 2015.

(51) Int. Cl. G07C 5/08; G06Q 30/06; G07C 5/12

(52) U.S. Cl. CPC G07C 5/0808; G07C 5/12; G07C 5/0825; G06Q 30/0631

(57) ABSTRACT

A vehicular grader diagnoses a vehicle under test (“VUT”). The grader includes a vehicular interface for receiving vehicular component statuses from a vehicular diagnostic and reporting system of the VUT. The grader computes scores from these vehicular component statuses. These scores are computed utilizing statistical vehicular data associated with vehicles similar to the VUT, thereby enabling the grader to generate an overall vehicular health report incorporating these scores. In some embodiments, the grader utilizes the vehicular health report to provide an objective recommendation for a purchase decision, a rental decision, a lending decision or a repair versus replacement decision.

### CROSS REFERENCE TO RELATED APPLICATIONS

This non-provisional application claims the benefit of U.S. provisional application No. 62/220,865, filed Sep. 18, 2015, which application is incorporated herein in its entirety by this reference.

This non-provisional application also claims priority to and is a continuation-in-part of U.S. non-provisional application Ser. No. 14/846,531, filed Sep. 4, 2015, pending, which is a Continuation of U.S. non-provisional application Ser. No. 12/568,677, filed on Sep. 29, 2009, abandoned, which are hereby fully incorporated by reference.

### BACKGROUND OF THE INVENTION

The present invention relates generally to a vehicle diagnostic system and a method therefor, and more particularly, to a vehicle diagnostic system and a method therefor which are adapted for enumerating test result of various vehicle components being diagnosed, and providing related information and suggestions in a vehicle diagnostic report, in addition to showing a status of the vehicle components as either “Pass” or “Fail”.

Currently, because of booming environmentalism as well as the continuously increasing number of vehicles running on the earth, stricter regulations have been announced in many countries for restricting the exhaust gas emission of vehicles.

In earlier days, for the purpose of reducing the exhaust gas emission of vehicles, emission control components such as an air flow meter, a catalytic converter and an oxygen sensor were required to be fitted to engines of vehicles. Hence, an on-board diagnostic (OBD) system was correspondingly proposed for monitoring whether or not the emission control components are in normal working condition.

A first generation OBD system, which is generally referred to as “OBD-I”, was compulsorily required to be fitted to all new vehicles sold in California starting in manufacturer's year 1988. The purpose of the OBD-I system was to alert the owner or the driver of the vehicle whenever a pollution-related component malfunction occurs, so that the malfunction can be fixed, and the corresponding pollution can be minimized. Further, an OBD-I system can also facilitate monitoring electrical malfunction of the main sub-systems or components, such as engine. When the malfunction is fixed, a malfunction indicator lamp (MIL) indicating the malfunction is then automatically turned off (dark).

The OBD-I system can monitor the operation of the engine, and when a malfunction of any emission control element occurs, the OBD-I alarms and lights the MIL on the instrument panel, so as to alert the driver to the malfunction and prompt repair of the emission control element to restore normal operation. Typically, when a malfunction is detected by the OBD-I system, the data and information referring to the malfunction is stored in a memory by an electronic control unit (ECU), and an OBD scan tool is employed to read the diagnostic trouble code (DTC) from the memory, so that the component of the malfunction and the characteristics of the malfunction can be determined.

The items which can be monitored by the OBD-I system mainly include the fuel injection system, oxygen sensor, exhaust gas recirculation (EGR) system, main input sensors and output actuators.

Subsequent to the OBD-I system, in 1994, the second generation OBD-II system was proposed. The OBD-II system is adapted for monitoring the age related or wear condition or malfunction of pollution-related sub-systems or components. The OBD-II system has standardized the vehicle health diagnostic specification, in which the emission value is restricted to be less than 1.5 times of that of a new vehicle, and the MIL is extinguished after a recovery operation so long as no similar malfunction occurs during the following three operating cycles. The OBD-II system further introduced additional monitoring items including catalytic converter (CAT), misfire test without illuminating the check engine light, evaporative system (EVAP) leak, EGR, and secondary air injection system.

Currently, a conventional vehicle diagnostic system can obtain information related to the components of the vehicle by accessing the OBD-II system loaded on the vehicle, so as to summaries a vehicle health diagnostic report enumerating items related to the components of the vehicle. However, in such a vehicle health diagnostic report, the enumerated items can be showed as “Pass/Fail” only, and therefore, the vehicle health diagnostic report cannot provide a more detailed view of the condition of components, and cannot therefore provide additional information and suggestions related to the vehicle components.

As such, it is very much desired to propose a vehicle health diagnostic system, adapted for diagnosing the health condition of a vehicle. The vehicle health diagnostic system is desired to be adapted for accessing information related to vehicle component status drawn from an OBD-II system by an interface connected thereto. The information for example includes diagnostic trouble codes (DTC), designated data, additional information, and parameters related to the status of the vehicle components. In such a way, an optimal vehicle health diagnostic report can be obtained. In such an optimal vehicle health diagnostic report, there is enumerated additional information and suggestions related to the vehicle components in addition to the items related to the components of the vehicle showed as “Pass/Fail”.

### SUMMARY OF THE INVENTION

To achieve the foregoing and in accordance with the present invention, a primary objective of the present invention is to provide a vehicle diagnostic system and a method therefor, adapted for diagnosing the health condition of a vehicle. The vehicle health diagnostic system and the method are adapted for obtaining a vehicle health diagnostic report, in which there is enumerated additional information and suggestions related to the vehicle components in addition to the items related to the components of the vehicle showed as “Pass/Fail”.

A further objective of the present invention is to provide a vehicle diagnostic system and a method therefor, adapted for diagnosing the health condition of a vehicle. The vehicle health diagnostic system and the method are adapted for accessing diagnostic trouble codes (DTC), designated data, additional information, and parameters related to the status of the vehicle components from an OBD-II interface, and correspondingly generating a vehicle health diagnostic report related to the vehicle components by processing the accessed diagnostic trouble codes (DTC), designated data, additional information, and parameters with a processing logic.

For achieving the foregoing objectives and others, the present invention provides a vehicle diagnostic system including a receiving/processing module, and a database.

The receiving/processing module is adapted for receiving the information related to a status of vehicle components from an OBD-II interface connected thereto. The information for example includes diagnostic trouble codes (DTC), designated data, additional information, and parameters related to the status of the vehicle components. The information is then analyzed by a processing logic, so as to generate a vehicle health diagnostic report with respect to the corresponding vehicle components. Specifically, the vehicle health diagnostic report includes one or more tables stored in the database. In the vehicle health diagnostic report including the one or more tables, in addition to enumerating the operation status of the vehicle components as “Pass/Fail”, there is also shown a detailed result of testing the vehicle components, and there is also provided additional information and suggestions related to the vehicle components. The processing logic is stored in receiving/processing module and/or in the database.

The database is adapted for storing a vehicle health diagnostic report including one or more tables, and/or a processing logic. The receiving/processing module accesses the database for retrieving the processing logic for preparing the vehicle health diagnostic report related to the vehicle components. Further, according to an aspect of the invention, the receiving/processing module accesses the database for retrieving the vehicle health diagnostic report including the one or more table stored in the database, and providing the vehicle health diagnostic report to other systems for printing the vehicle health diagnostic report onto paper or displaying the vehicle health diagnostic report on a display screen, so as to allow the user to be aware of the additional information and suggestions related to the vehicle components.

In the operation of utilizing the vehicle health diagnostic system according to the present invention to diagnose a vehicle, first the receiving/processing module receives the information, accessing information related to a status of vehicle components from an OBD-II interface connected thereto. The information for example includes diagnostic trouble codes (DTC), designated data, additional information, and parameters related to the status of the vehicle components. Then, the receiving/processing module analyzes the received information with the processing logic, thus obtaining a vehicle health diagnostic report with respect to the corresponding vehicle components. Specifically, the vehicle health diagnostic report includes one or more tables, and the one or more tables can be stored in a database. The receiving/processing module accesses the database to retrieve the vehicle health diagnostic report including the one or more tables, and outputs the retrieved vehicle health diagnostic report to other systems. Finally, the vehicle health diagnostic report is printed onto paper or displayed on a display screen, so as to allow the user to be aware of the additional information and suggestions related to the vehicle components.

A sophisticated OBD-II system was proposed and implemented across all vehicles sold in the US from 1996 onwards. In particular, this specification, SAE J/1979, is highly standardized and diagnostic tools with common interfaces can be freely interchanged between vehicles. Of note is that although the monitored functions are standardized, not all manufacturers provide all listed data and most have proprietary information available from the OBD-II system. The majority of manufacturers are members of the Equipment and Tool Institute (ETI) which sells access to the data-sets that describe which manufacturer supports which DTC information. In some cases, individual manufacturers sell their documentation only through a direct channel. The OBD-II system is adapted for monitoring the aging condition or malfunction of pollution-related sub-systems or components. Unlike the simpler OBD-I, the OBD-II system has standardized the vehicle diagnostic specification and most parameters are continuously encoded. This means that instead of simple threshold triggers that are working or not-working sensor signals, the sensors transmit a value to the OBD-II system and the threshold triggers are set in software. Of especial importance is that by monitoring the value of the sensor signals over time, any trend or degradation in the operation of a particular system or subsystem can be measured and recorded. One specification item, by way of example, is that the pollutant emission value is restricted to be less than 1.5 times of that of the new vehicle, which would result in the MIL being illuminated if the limit were to be exceeded. The MIL is reset in the event of a spurious reading or transient event after a recovery period if there is no similar malfunction over the course of the next three operating cycles. The OBD-II system further introduced some monitoring items including catalytic converter (CAT) status monitoring, a misfire test (which does not result in a check engine light, evaporative system (EVAP) leak checking, Exhaust Gas Regeneration measurements and secondary air injection system. A person skilled in the art will appreciate that there exist variants to the OBD-II SAE standard and the same principles of operation used here apply equally to those systems

Currently, a conventional vehicle diagnostic system can retrieve information related to the components of the vehicle by accessing the OBD-II system loaded on the vehicle so as to summarize a vehicle health diagnostic report. This report enumerates items related to the components of the vehicle from which data is drawn. However, in such a report, the enumerated items can be shown as “Pass/Fail” only and, therefore, the diagnostic report cannot provide a more detailed result of the component status. Neither can the report provide additional information and suggestions related to the vehicle, its condition and components.

As such, it is evident that there exists an urgent need for a vehicle health diagnostic system, adapted for diagnosing the condition of a vehicle. The vehicle health diagnostic system is preferred to be adapted for accessing information related to the status of vehicle components from an OBD-II interface connected to the vehicle. The information for example includes diagnostic trouble codes (DTC), designated data, additional information, and parameters related to the status of the vehicle components. In such a way, a vehicle health diagnostic report can be obtained. Such a vehicle health diagnostic report enumerates additional information and suggestions related to the vehicle components in addition to the items related to the components of the vehicle showed as “Pass/Fail”.

It should be clear that the term “table” or “tables” are used for simplicity in the summary above and throughout this document and any data structure may be used for efficiently building a record, be they lists, linked lists, triestructures or any other structure. In addition, the term printing includes electronic printing to create a portable document such as a PDF file or an HTML file. Information may also be presented to a user on any type of appliance that has a screen and may also be provided in audible form.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a structure of a vehicle diagnostic system and the operation thereof according to an embodiment of the present invention;

FIG. 2 is a flow chart illustrating steps of a vehicle diagnostic method executed with the vehicle diagnostic system of FIG. 1 according to an embodiment of the present invention;

FIG. 3 is a flow chart illustrating steps of a vehicle diagnostic method executed with the vehicle diagnostic system of FIG. 1 according to a further embodiment of the present invention;

FIG. 4 is a flow chart illustrating a detailed procedure of the step of receiving the information related to a status of the vehicle components of FIGS. 2 and 3;

FIG. 5 is a flow chart illustrating a detailed procedure of the step of generating a vehicle health diagnostic report of FIGS. 2 and 3;

FIG. 6 is a flow chart illustrating the procedure of executing the vehicle diagnostic method of FIG. 3 according to an embodiment of the present invention;

FIG. 6(a) is a supplementary flow chart that shows how statistical information is incorporated into the embodiment of FIG. 6.

FIG. 7a is a summary table showing a testing result of a plurality of sensors;

FIG. 7b is a summary table showing a testing result of the vehicle component test;

FIG. 7c is a summary table showing a testing result of the DTC test;

FIG. 7d is a summary table showing a testing result of the emission test;

FIG. 8a is a table showing a testing result of a plurality of sensors of the OBD-II system;

FIG. 8b is a table showing a result of a component test of the OBD-II system;

FIG. 8c is a table showing a result of a DTC test of the OBD-II system;

FIG. 8d is a table showing a result of an emission test of the OBD-II system; and

FIG. 9 shows the table of 8a supplemented with additional sensors indicating the status of advanced vehicular components.

### DETAILED DESCRIPTION OF THE PREFERRED EMBODIMENT

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “optimally,” “before,” “after,” “lastly,” and “finally,” are not meant to limit the scope of the present invention as the embodiments disclosed herein are merely exemplary.

The accompanying drawings are included to provide a further understanding of the invention, and are incorporated in and constitute a part of this specification. The drawings illustrate embodiments of the invention and, together with the description, serve to explain the principles of the invention.

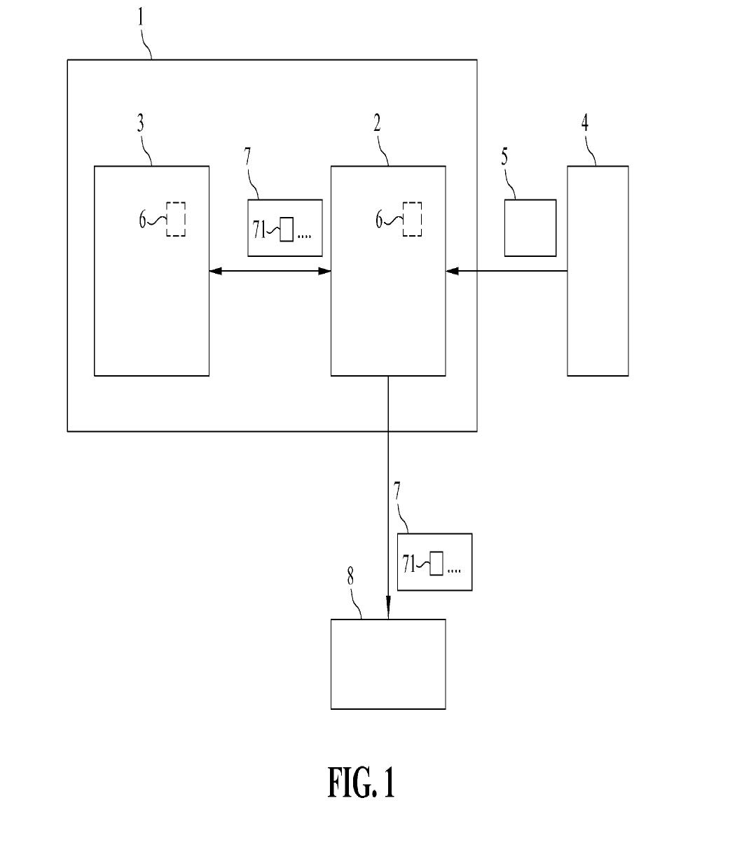

FIG. 1 is a schematic diagram illustrating a structure of a vehicle diagnostic system and the operation thereof according to an embodiment of the present invention. Referring to FIG. 1, there is shown a vehicle diagnostic system 1 including a receiving/processing module 2, and a database 3.

The vehicle diagnostic system 1 is installed in a notebook computer, and/or a personal computer, and/or a server. The receiving/processing module 2 for example is software and/or hardware, and/or firmware. The receiving/processing module 2 and the database 3 are disposed in a notebook computer, and/or a personal computer, and/or a server. For example, the receiving/processing module 2 and the database 3 are both positioned in a notebook computer, or the receiving/processing module 2 and the database 3 are both positioned in a personal computer, or the receiving/processing module 2 and the database 3 are both positioned in a server. Alternatively, according to an aspect of the embodiment, the receiving/processing module 2 is positioned in a personal computer, while the database 3 is positioned in a server. According to a further aspect of the embodiment, the receiving/processing module 2 is positioned in a notebook computer, while the database 3 is positioned in a server.

The elements comprising the system described may be entirely self-contained in a single computing appliance or may be distributed between more than one appliance. For example the data collection from the OBD-II port in the vehicle may be done remotely and the information sent to another location for storage and/or processing. In one implementation the receiving/processing module, 2, may be a hardware state machine that simply reads the data from the OBD-II port, compresses the information for efficiency and transmits it to the computing appliance where the information is re-constituted, stored and then used to develop a result, useful to the user of the system.

The receiving/processing module 2 is adapted for receiving information 5 related to a status of vehicle components from an OBD-II interface 4 connected thereto. For example, the information includes diagnostic trouble codes (DTC), designated data, additional information, and parameters related to the status of the vehicle components. The received information 5 is then analyzed and processed by a processing logic 6, so as to obtain a vehicle health diagnostic report 7 related to the vehicle components being diagnosed. The vehicle health diagnostic report 7 includes one or more table(s) 71. The table(s) 71 is/are stored in the database 3. In the vehicle health diagnostic report 7 including the table(s) 71, in addition to enumerating the operation status of the vehicle components as “Pass/Fail”, there is also showed a testing result of the vehicle components, and there are also provided additional information and suggestions related to the vehicle components. The processing logic 6 is stored in receiving/processing module 2 and/or in the database 3.

The database 3 is adapted for storing the vehicle health diagnostic report 7 including the table(s) 71, and/or the processing logic 6. The receiving/processing module 2 accesses the database 3 for retrieving the processing logic 6 therefrom and for preparing the vehicle health diagnostic report 7 related to the vehicle components. Further, according to an aspect of the invention, the receiving/processing module 2 accesses the database 3 for retrieving the vehicle health diagnostic report 7 including the table(s) 71 stored in the database 3, and provides the vehicle health diagnostic report 7 to an additional system 8 for printing the vehicle health diagnostic report 7 onto paper or displaying the vehicle health diagnostic report 7 on a display screen (not shown in the drawings), so as to inform the user of the additional information and suggestions related to the vehicle components.

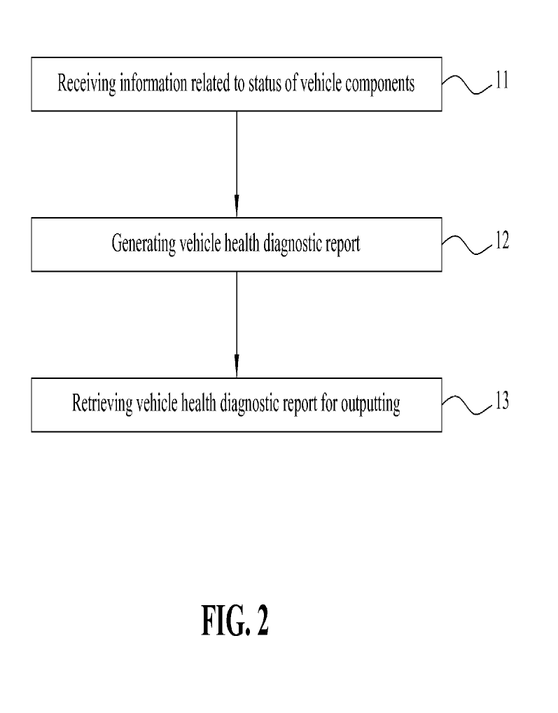

FIG. 2 is a flow chart illustrating steps of a vehicle diagnostic method executed with the vehicle diagnostic system of FIG. 1 according to an embodiment of the present invention. Referring to FIG. 2, at step 11, the receiving/processing module is utilized to receive information 5 related to a status of vehicle components from an OBD-II interface 4 connected thereto. For example, the information includes diagnostic trouble codes (DTC), designated data, additional information, and parameters related to the status of the vehicle components. Then, the flow goes to step 12.

At step 12, the received information 5 is analyzed and processed by a processing logic 6, so as to obtain a vehicle health diagnostic report 7 related to the vehicle components being diagnosed. The vehicle health diagnostic report 7 includes the table(s) 71. The table(s) 71 is/are stored in the database 3. Then, the flow goes to step 13.

At step 13, the receiving/processing module 2 accesses the database 3 for retrieving the vehicle health diagnostic report 7 including the table(s) 71 stored in the database 3, and provides the vehicle health diagnostic report 7 to an additional system 8.

The table or data structure, 71, may be the result of arranging all of the received information, 5, from the vehicle. The data structure may be modified so as to produce a numerical score. In one implementation, the numerical score is linearly related to the raw OBD-II reported value and scaled in the pre-defined minimum to maximum range. In another, the score is associated with a color which allows a user to infer a quality of performance; by way of example, a value of 33% displayed in green might signify that the parameter reported is acceptable, which avoids a user having to attempt to interpret whether a numeric score reflects a good or bad result. In a similar vein, a yellow color may reflect a value which suggests that the parameter is still indicative of a functioning senor but that service might be required at some point, and a red color might be considered as an urgent case where replacement of repair is required. A range of colors may be used. In yet another implementation, when shown on a display, the score value may be colored and blinked on or off to draw attention to a parameter which suggests a serious condition. In a printed document, the effect of blinking may be achieved using radial lines surrounding or proximate to the parameter.

The example above is based upon a single vehicle transaction. An improvement in the system occurs when the data from multiple vehicles can be accumulated in a database structure. Because each vehicle is identified by some sort of serial number, such as the Vehicle Identification Number, or VIN, and OBD-II in Mode 9, PID 0x02 (hexadecimal 2) returns the value of the vehicle ID, the vehicle type and manufacturer can be readily identified. Beyond a simple single-vehicle report, a user may now be provided with a score evaluation which compares the test vehicle of interest with the condition of the fleet of comparable vehicles. This enables a user to compare a range of vehicles so that it is practical to select a vehicle that is statistically less likely to fail in the short term.

By way of example as to the use of this application, a prospective purchaser of a vehicle, when offered a choice of say, one of three vehicles, might request a health comparison of each of the vehicles. A simple single vehicle report might show that each vehicle was in acceptable condition and it might be difficult for a lay-person to be able to distinguish between the choices. A local record of each vehicle might then be considered and a simple comparison would allow the vehicles to be ranked in terms of which might be the better purchase given a set of parameters that the prospective buyer might input to the system. For example one buyer might decide that the best vehicle was one which had a simple, easily repairable fault which was a well known weakness for that type. Another might decide that the lowest mileage vehicle was preferred whilst yet another might select the vehicle with the best average fuel consumption. With a small sample, meaningful comparisons are difficult, but with this invention, a prospective buyer has an ability to compare a selected vehicle against a potentially large statistical database. By allowing the system to request statistical data collected from all vehicles of this type that have been analyzed from a central or distributed data collection, the vehicle to be compared can be evaluated in the context of the whole population. Now, the report shows the buyer if the vehicle is merely average or whether it is significantly better than the average. In addition, the scope of the comparison may include just the model year under consideration or may be any range of model years. Further, trouble points can be featured more prominently and in one implementation the buyer is shown a projected cost of ownership analysis to allow for a meaningful decision basis.

In addition to guideline scores derived from the raw parameter data from the vehicle, certain combinations of parameter values are known to reflect concerns that component or subsystem faults are imminent. For example an Oxygen Sensor which shows an unexpected value approaching a defined limit coupled with a Catalytic Converter sensor anomaly may indicate that a persistent misfire has been occurring and that the converter has been poisoned in part. Contrast this with an indication that coolant temperature is persistently low. The former implies a costly repair whereas the latter suggests that a thermostat may have stuck open; a less costly problem to repair.

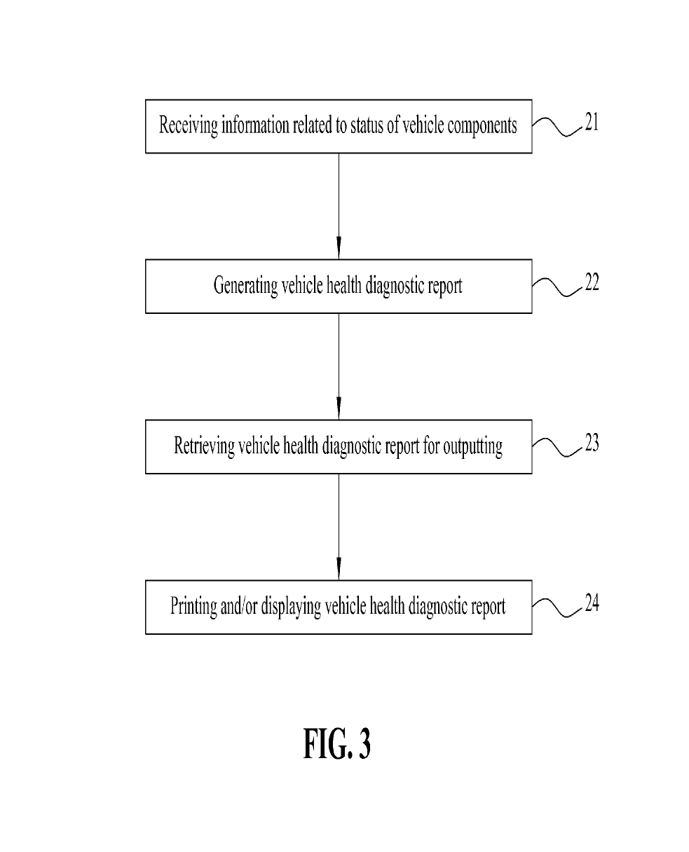

FIG. 3 is a flow chart illustrating steps of a vehicle diagnostic method executed with the vehicle diagnostic system of FIG. 1 according to a further embodiment of the present invention. Referring to FIG. 3, at step 21, the receiving/processing module is utilized to receive information 5, detailed in FIG. 1, related to a status of vehicle components from an OBD-II interface 4, detailed in FIG. 1, connected thereto. For example, the information includes diagnostic trouble codes (DTC), designated data, additional information, and parameters related to the status of the vehicle components.

At step 22, the received information 5 is then analyzed and processed by a processing logic 6, so as to obtain a vehicle health diagnostic report 7 related to the vehicle components being diagnosed. The vehicle health diagnostic report 7 includes one or more table(s) 71. The table(s) 71 is/are stored in the database 3.

The processing logic, 6, may be implemented as a software or firmware program and may be stored in either or both of the receiving/processing module, 1, in FIG. 1, and the database module, 3. The processing logic, 6, may also be implemented in hardware as, for example, a state machine using a gate array. The physical machine may be present in the receiving/processing module along with any firmware that is needed to initialize this element. The firmware may also be stored in the database module so that it may be separated from the physical machine. As explained above, the processing logic may produce a tabulation or a list or any other data structure that may be stored in the database and may be communicated to another remote database so that it may be stored and may also be aggregated into a larger database for subsequent statistical analysis. The tables or data structures stored in the database module, 3, may contain any combination of raw data, partially processed data or fully processed data. The data may be formatted for printing as a document or it may be formatted for some other use as a subsequent step prior to being produced as a man-readable output.

At step 23, the receiving/processing module 2 accesses the database 3 for retrieving the vehicle health diagnostic report 7 including the table(s) 71 stored in the database 3, and provides the vehicle health diagnostic report 7 to an additional system 8. The additional system may be a simple slave such as a printer that accepts prepared data for printing to a permanent hard copy or it may be a computing appliance that accepts data in any format that it then post processes prior to rendering for use.

At step 24, the additional system 8 prints the vehicle health diagnostic report 7 onto paper or displays the vehicle health diagnostic report 7 on a display screen, so as to allow the user to be aware of the additional information and suggestions related to the vehicle components.

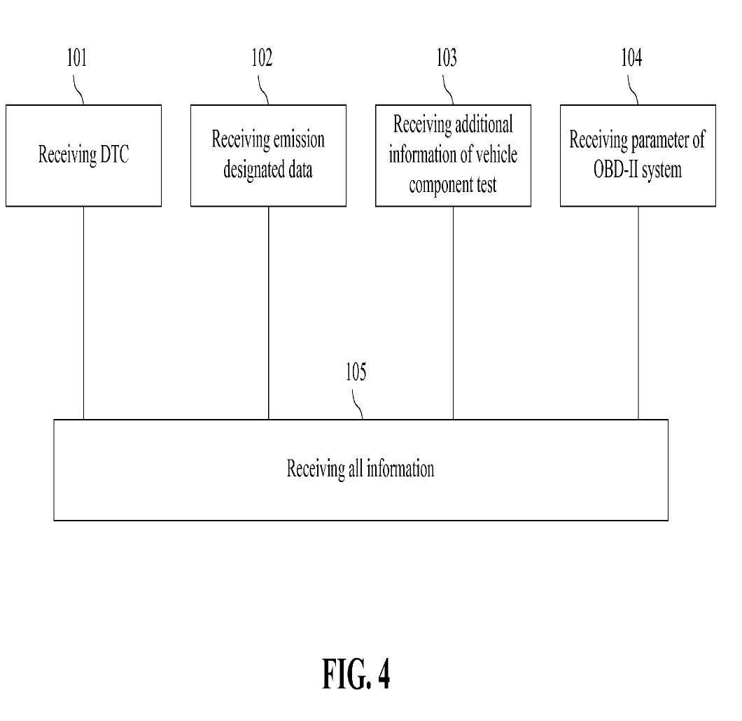

FIG. 4 is an example flow chart illustrating a detailed procedure of the step of receiving the information related to a status of the vehicle components of FIGS. 2 and 3. Referring to FIG. 4, at step 101, the receiving/processing module 2 receives the DTC, and then the flow goes to step 105, where the received data is stored. At step 102, the receiving/processing module 2 receives a designated data of an evaporative emission system and/or a fuel injection system, and then the flow goes to step 105, where the received data is stored. At step 103, the receiving/processing module 2 receives additional information of the component test, and then the flow goes to step 105, where the received data is stored. At step 104, the receiving/processing module 2 receives parameters of the OBD-II system, and then the flow goes to step 105, where the received data is stored. It should be evident to the skilled man that the OBD-II standard continues to evolve and the four categories used in this foregoing example are common classifications; step 104 enables all stored parameters to be harvested from the vehicle and these too may be categorized. Though this example does not elaborate on how one might assign categories, mere naming does not change the fundamental nature of acquiring all available data and then processing it in concert with other information.

At step 105, the receiving/processing module 2 has received and stored all information related to the status of the vehicle components. These stored parameters may be compressed or encoded to limit the distribution, intended or otherwise, so that information is kept in private form. Ideally the vehicle identification is separated from the data and may be reconstructed through a more secure storage system. One example is that the VIN may be stored using a hash table so that the data-set corresponding to that vehicle may not be easily identified without the additional information.

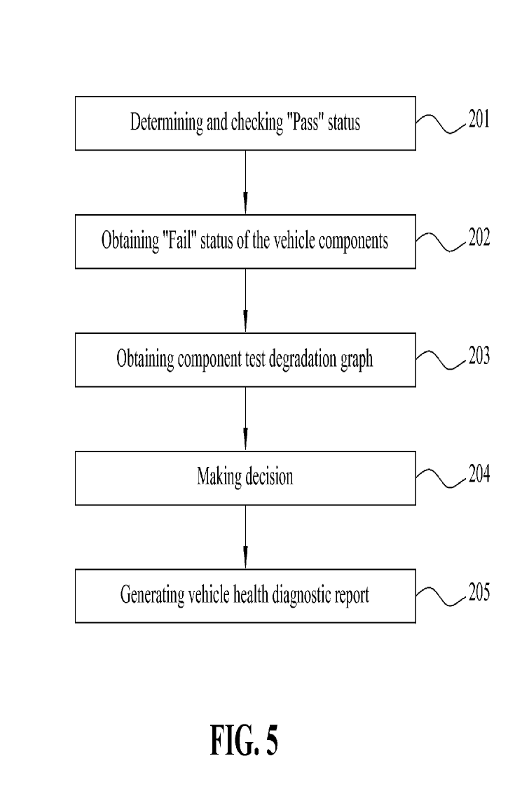

FIG. 5 is a flow chart illustrating a detailed procedure of the step of generating a vehicle health diagnostic report of FIGS. 2 and 3. As shown in FIG. 5, at step 201, the receiving/processing module 2 receives the information 5, for example, the DTC, the designated data, the additional information, and the parameters, and the processing logic 6 analyzes and processes the received information 5, so as to determine a “Pass” status of the vehicle components. A “Pass” determination is usually a go/no-go test where thresholds are predetermined by regulation or by manufacturer's advisories or service bulletins. These are absolute decisions and an example would be the automated performance of a smog test where a vehicle either passes or fails. The “Pass” determination may be at a system level for the entire vehicle or may be at the level of the condition of individual components or else might be arranged in terms of sub-systems comprised of several components.

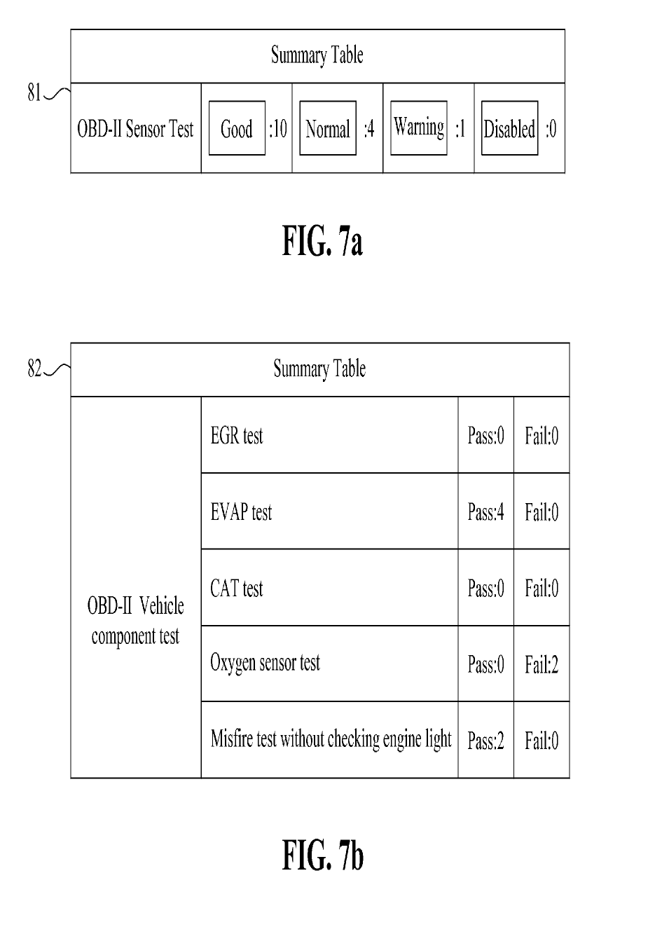

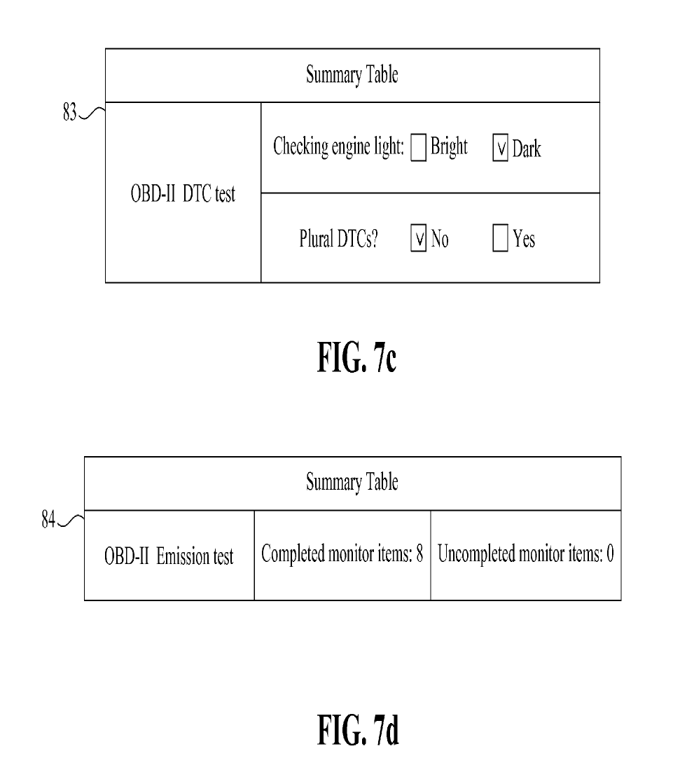

At step 202, in accordance with the analysis conducted by the processing logic 6, the receiving/processing module 2 determines a “Fail” status of the vehicle components from more than one summary table (an example of a simple summary table set is shown in the drawings at FIG. 7a through 7d.)). The more than one summary tables show a testing result of a plurality of sensors, and/or a testing the vehicle component test, and/or a testing result of the DTC test, and/or a result of an emission test of an evaporative emission system and/or a fuel injection system. The testing result of the sensors for example shows a quantity of sensors determined as “Good”, and/or “Normal”, and/or “Warning”, and/or “Disabled”. The testing result of the vehicle components for example shows a quantity of vehicle components determined as “Pass” or “Fail”. The testing result of the DTC test for example shows the bright/dark status of the engine light related to the DTC, and whether the DTC is plural. The result of the emission test for example shows the quantity of the monitor items.

In general, single points of failure may be fatal to the status of the vehicle or sub-system, but sensors often operate in concert with others so that there is some redundancy to protect against complete failure. For example it might be disastrous to shut an engine off because of a sensor error. In another example, a common problem is that a vehicle user may improperly attach the cap to the fuel tank which results in a warning that will normally illuminate the “Check Engine” light. Although this inevitably exceeds a monitoring threshold, the condition will not damage the vehicle but may exceed emissions limits by releasing unintended gasoline vapor into the atmosphere. Therefore, a test result that shows a difficulty is better handled by determining if there are supporting error indications rather than presenting a “Fail” determination in isolation. In this latter case, a conditional “Fail” may be an option for a status report even though the malfunction indicator lamp is illuminated.

At step 203, in accordance with the analysis conducted by the processing logic 6, and according to the measurement, upper specification, lower specification of the vehicle components, the receiving/processing module 2 calculates to obtain a component test degradation graph (not shown in the drawings). This graph may show where, as a percentage of the nominal range of operation, a particular component is operating. Because the invention maintains records in its database for all vehicles tested by the system, it is possible to retrieve past records for any particular vehicle and build a trend report that shows change over time in the status of any monitored individual component of the vehicle. Tabulated information may be in any structural format including lists and linked lists, tries etc., and may include time and mileage (distance traveled including kilometers) information so that meaningful trend information can be inferred and displayed to a user.

At step 204, according to the component test degradation graph, the receiving/processing module 2 determines whether the testing result of the sensors, and/or vehicle components, and/or DTCs, and/or emission test are “Pass” or “Fail.” In one implementation, a prognostic failure schedule may be approximated to provide longevity guidance to the user. This failure prognostication may be a simple linear extrapolation or else may be an algorithmic estimate with actual failure statistics from similar vehicles factored into the determination. Incorporated into the estimation of the time to failure may be a guideline that may be interpreted as a cost of ownership of the vehicle based on either time, distance or some combination of both of these variables.

At step 205, the receiving/processing module 2 generates a vehicle health diagnostic report 7 related to the vehicle components being diagnosed. The vehicle health diagnostic report 7 includes one or more tables, 71, and the table(s) 71 is/are stored in the database 3. This report may incorporate derived information as well as the factual data that is recorded from the vehicle itself. The term ‘table’ may be interpreted to mean any data structure that allows information to be stored and retrieved for use.

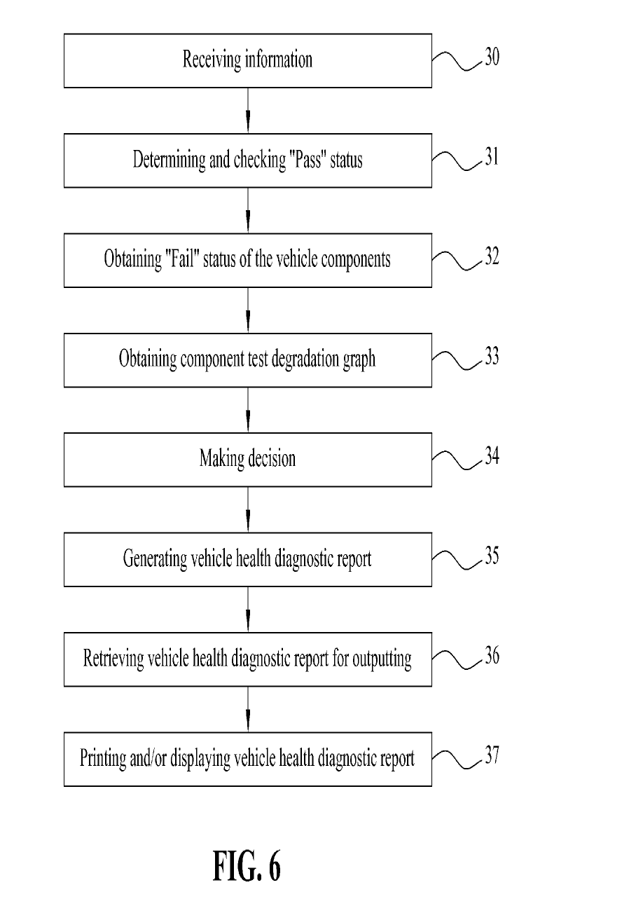

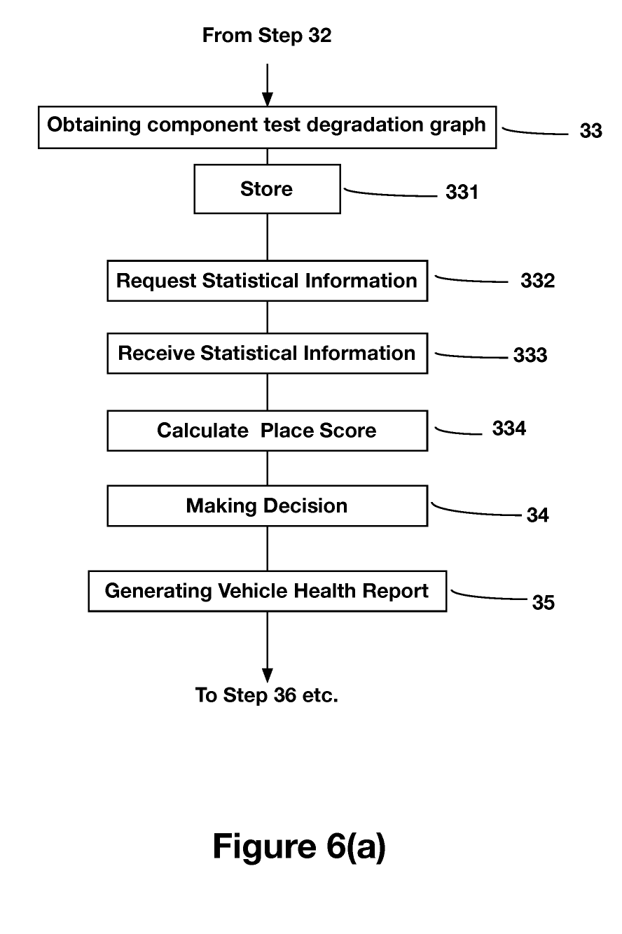

FIG. 6 is a flow chart illustrating the procedure of executing the vehicle diagnostic method of FIG. 3 according to an embodiment of the present invention. Referring to FIG. 6, firstly, at step 30, the receiving/processing module 2 receives the DTC, the designated data of the evaporative emission system and/or a fuel injection system, the additional information of the component test, the parameters of the OBD-II system. In other words, at step 30, the receiving/processing module 2 receives all information 5 related to the status of the vehicle components, and then the flow goes to step 31. The information, 5, may be received in one single session or information may be collected as a sequence of sessions so as to be able to be able to acquire time variable information. By way of example, as an engine moves from the starting configuration to the warm configuration, sensor conditions will change and will give an indication of the deviation from the anticipated activity. For example if the heating rate of the coolant is very slow, this may point to a malfunctioning thermostatic valve that may not otherwise alert the operator of the vehicle yet affects the economy rating of the vehicle by compromising fuel consumption.

At step 31, facilitated by the processing logic, the receiving/processing module 2 determines and checks the “Pass” status of the vehicle components.

At step 32, in accordance with the analysis conducted by the processing logic 6, the receiving/processing module 2 determines a fail status of the vehicle components from one or more tables 81, 82, 83, and 84. FIG. 7a is a summary table 81 showing the testing result of a plurality of sensors. FIG. 7b is a summary table 82 showing a testing result of the vehicle component test. FIG. 7c is a summary table 83 showing a testing result of the DTC test. FIG. 7d is a summary table 84 showing a testing result of the emission test of an evaporative emission system and/or a fuel injection system. As shown in FIG. 7a, the testing result of the sensors shows 10 “Good”, 4 “Normal”, 0 “Warning”, and 1 “Fail”. As shown in FIG. 7b, the testing result of the vehicle component test includes 0 “Pass” and 0 “Fail” of the exhaust gas recirculation (EGR) system test, 4 “Pass” and 0 “Fail” of the evaporative emission system (EVAP) test, 0 “Pass” and 0 “Fail” of the oxygen sensor system test, and 2 “Pass” and 0 “Fail” of the engine misfire test without checking engine light. As shown in FIG. 7c, the testing result of the DTC test the engine lamp, which is related to the DTC, is turned dark (extinguished). As shown in FIG. 7d, the testing result of the emission test shows that there are 8 monitor items tested, and there is no monitor item not tested.

At step 33, in accordance with the analysis conducted by the processing logic 6, and according to the measurement, upper specification, lower specification of the vehicle components, the receiving/processing module 2 calculates to obtain a component test degradation graph (not shown in the drawings) as explained in paragraph [0061], supra.

At step 34, according to the component test degradation graph, the receiving/processing module 2 determines whether the testing result of the sensors, and/or vehicle components, and/or DTCs, and/or emission test are “Pass” or “Fail”.

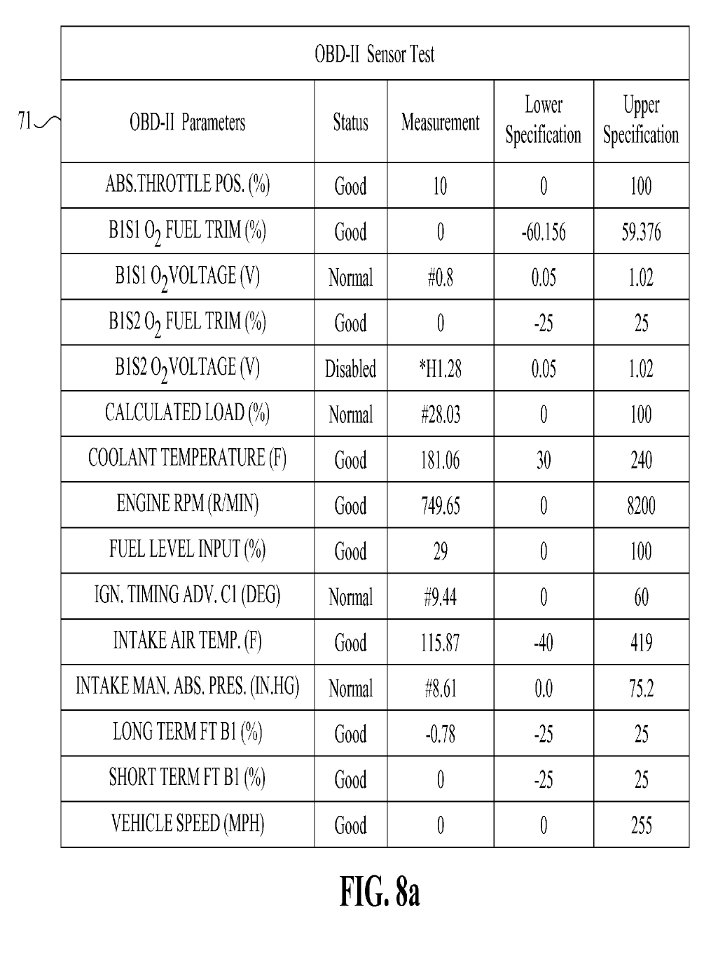

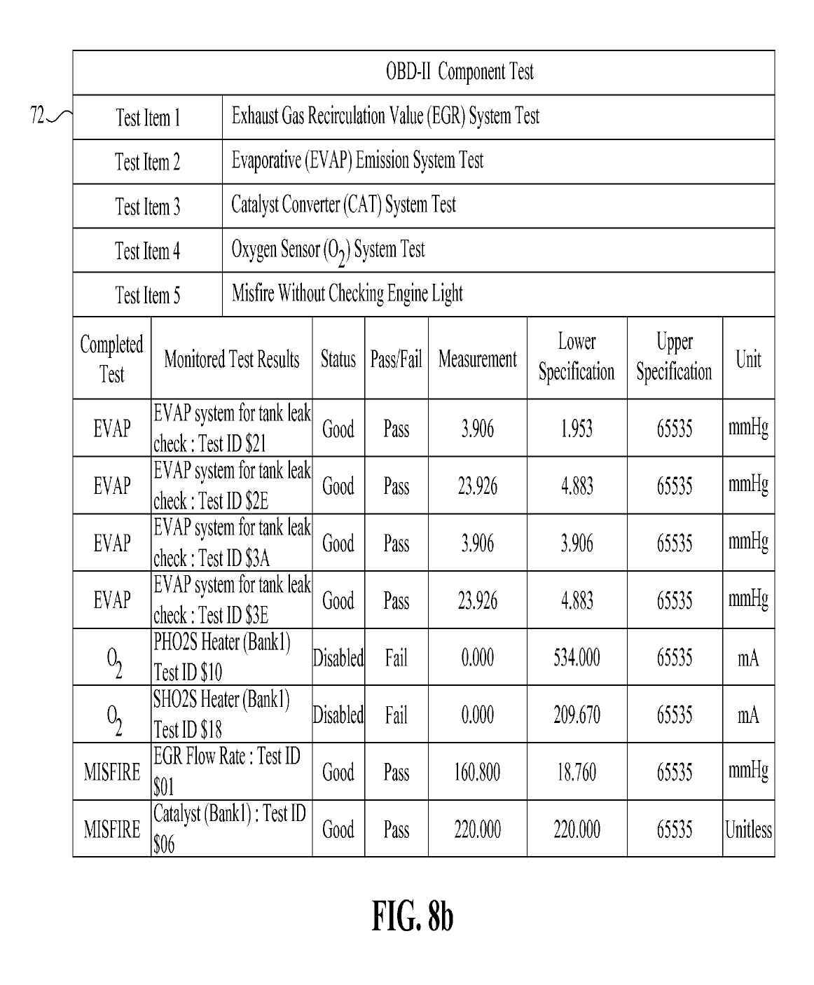

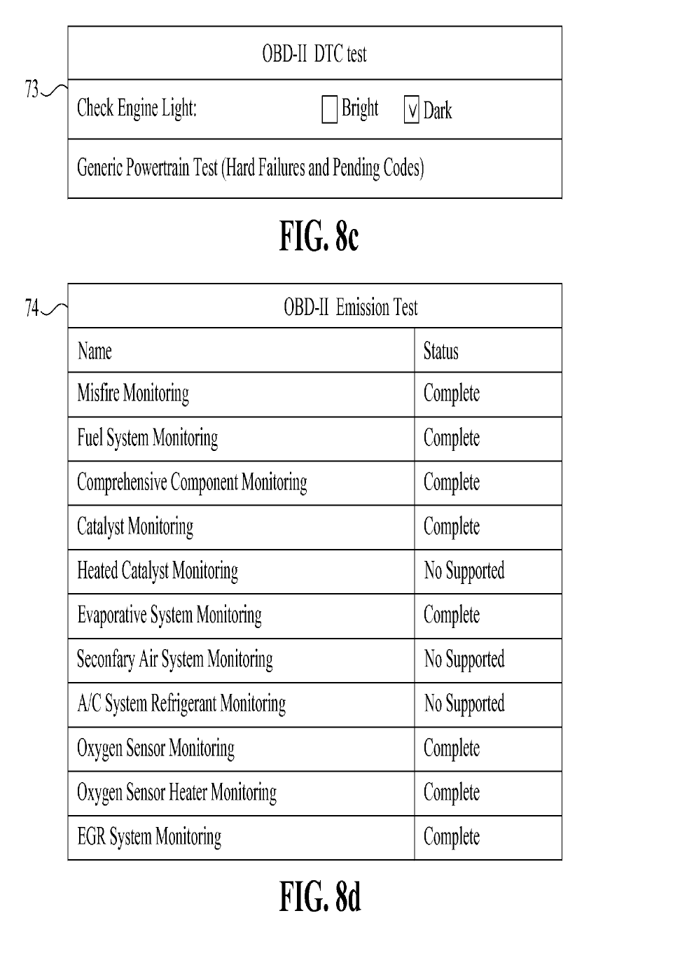

At step 35, the receiving/processing module 2 generates a vehicle health diagnostic report 7 related to the vehicle components being diagnosed. The vehicle health diagnostic report 7 includes one or more table(s) 71, and the table(s) 71 is/are stored in the database 3. Specifically, the vehicle health diagnostic report 7 includes one or more tables, for example 71, 72, 73, 74. Examples of these tables 71, 72, 73, 74 are respectively shown in FIGS. 8a through 8d. FIG. 8a illustrates the table 71, which shows a testing result of a plurality of sensors of the OBD-II system. FIG. 8b illustrates the table 72 which shows a result of a component test of the OBD-II system. FIG. 8c illustrates the table 73 which shows a result of a DTC test of the OBD-II system. FIG. 8d illustrates the table 74 which shows a result of an emission test of the OBD-II system. Then the flow goes to step 36.

At step 36, the receiving/processing module 2 accesses the database 3 for retrieving the vehicle health diagnostic report 7 including the tables 71, 72, 73, and 74 stored in the database 3, and provides the vehicle health diagnostic report 7 to the additional system 8. The, the flow goes to step 37.

At step 37, the additional system 8 prints the vehicle health diagnostic report 7 onto paper or displays the vehicle health diagnostic report 7 on a display screen, so as to allow the user to be aware of the additional information and suggestions related to the vehicle components. In one implementation the additional system, 8, prints the report as an electronic file and in a second implementation, the additional system appends an acoustic record to supplement the electronic report. These acoustic components may be supplementary information that may be used in conjunction with the textual report.

FIG. 6(a) is a supplement to FIG. 6 and shows how the “big” data that references a statistical collection of all cars of the same type and model year may be added into the existing process. Step 33 builds a test degradation graph for the vehicle under test. Instead of pressing on to the decision task at step 34, the process may be interrupted by a task at step 331 to store the information from step 33 and then request the statistical information from the database that contains the statistical information at step 332. Typically other parameters to be considered such as, for example, the specific model or all models of that vehicle type with that powertrain, or all models in category within a year either side of the model year of the vehicle under test will be taken from the set up interaction with the user, viewer or buyer or other interested party. This may be done at test time or by using stored data from earlier test times and need not be at the time at which there was an actual connection to the vehicle. Once the parameters that define the request have been sent, the system waits for the database that contains the information to respond. The system then receives the data requested at step 333 and uses this to calculate a score at step 334 that reflects the vehicle in terms of its place in the class of all vehicles in the category. The process then falls back into the process of FIG. 6 at step 34 and continues. The generation of the health report at step 35 will be defined by process being run by the system. A health report for the single vehicle under test may be in a different format to the report for the vehicle when being scored relative to the group since additional information may be available. For example, when the place score is generated the system may use information about failure statistics to infer components at risk and may then be able to present cost estimates and guidance for incipient maintenance problems. Absent a meaningful comparative group, this information in isolation is unlikely to be reliable. By way of elaboration, a failing oxygen sensor in the exhaust system is likely to cause an emissions warning faulting the whole Catalytic converter sub-system rather than simply identify the oxygen sensor as being close to failing. If however it is known that the failure mode is the sensor itself across a large dataset, then the cost of repair is less likely to be for the entire converter system.

FIG. 7a is a summary table 81 showing the testing result of a plurality of sensors. As shown in FIG. 7a, the testing result of the sensors shows 10 “Good”, 4 “Normal”, 0 “Warning”, and 1 “Fail”.

FIG. 7b is a summary table 82 showing a testing result of the vehicle component test. As shown in FIG. 7b, the testing result of the vehicle component test includes 0 “Pass” and 0 “Fail” of the exhaust gas recirculation (EGR) system test, 4 “Pass” and 0 “Fail” of the evaporative emission system test, 0 “Pass” and 0 “Fail” of the oxygen sensor system test, and 2 “Pass” and 0 “Fail” of the engine misfire test.

FIG. 7c is a summary table 83 showing a testing result of the DTC test. As shown in FIG. 7c, the testing result of the DTC test the engine lamp, which is related to the DTC, is turned dark.

FIG. 7d is a summary table 84 showing a testing result of the emission test of an evaporative emission system and/or a fuel injection system. As shown in FIG. 7d, the testing result of the emission test shows that there are 8 monitor items tested, and there is no monitor item not tested.

FIG. 8a illustrates the table 71, which shows a testing result of a plurality of sensors of the OBD-II system. FIG. 8b illustrates the table 72 which shows a result of a component test of the OBD-II system. FIG. 8c illustrates the table 73 which shows a result of a DTC test of the OBD-II system. FIG. 8d illustrates the table 74 which shows a result of an emission test of the OBD-II system.

As shown in FIGS. 8a through 8d, the vehicle health diagnostic report 7 including a plurality of tables 71, 72, 73, 74, does not only show the testing result of the vehicle component test, but also provides additional information and suggestions related to the vehicle components, e.g., the status of the components are “Good”, “Normal”, “Warning”, or “Disabled”.

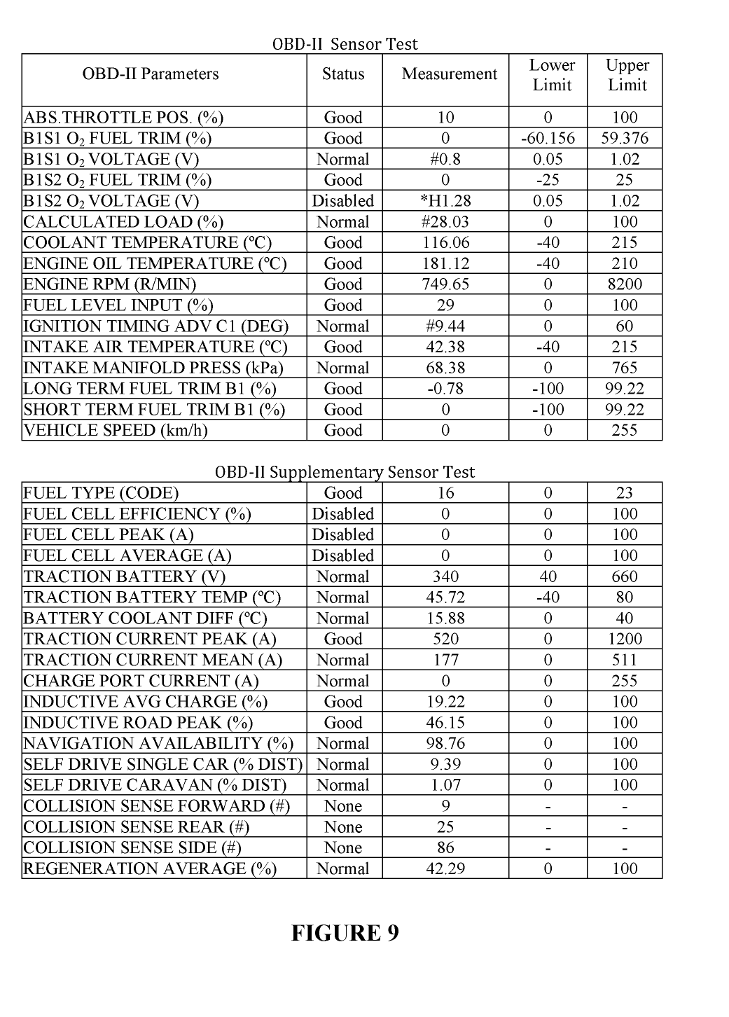

Turning now to FIG. 9, in addition to limited standard tests for older vehicles, shown in the first or upper part of the figure and identified as the OBD-II Sensor Test, the second or lower part of the figure identified as OBD-II Supplementary Sensor Test illustrates the addition of extended parameters to include modern sensors. In keeping with the enormous complexity of the systems of a modern vehicle, manufacturers of sensors have made huge investments in sensor technologies so that the economic advantages of being able to monitor every variable in a vehicle are practical. The movement to hybrid and electric vehicles has created a whole new set of parameters to do with the energy storage and delivery systems. For example, the OBD-II standard recognizes that multi-fuel vehicles are becoming far more common and there is an inquiry identity that returns the Fuel Type code which identifies the power plant capability of the vehicle under test. The first line of the second or lower part of FIG. 9 shows a returned value of 16 which is the predefined code that identifies the vehicle as being a bi-fuel vehicle running electric and combustion engine. The grouping shown in this example selects for the purposes of illustration functionality that is to be expected in a modern technology vehicle. If the vehicle is constructed so as to incorporate a fuel cell, the likely fuel may be Hydrogen and it is expected that the attributes of the cell assembly (typically there will be many discrete single cells coupled electrically to provide the desired performance capabilities) would be the operating levels in terms of the current being supplied as a peak value and average value. Extended use would allow the computation and delivery of an efficiency value to be used as an indication that service might be required as the cells approach their limiting parameters with age or fuel cleanliness. Similarly a traction battery, regardless of its construction, may have parameters that must be measured to ensure battery health is maintained, such as its terminal voltage or individual cell voltage, temperature values which may be a single valued or a plurality of values as applicable. If the battery has a cooling system then the performance of this system must be monitored and in this example the differential temperature between battery and the heat-exchanged coolant may be used as a condition parameter. Peak and average currents are important in defining the durability of the battery and derivative parameters may be used to infer the overall age related quality of the battery; an example here would be a rate of temperature change relative to power consumption over time.

It is equally important to monitor the charging performance of battery systems and this supplementary sensor test example illustrates not simply the static charge rate at the vehicle mounted charging port, but also the performance of technologies such as inductive chargers embedded in specialty roadways. Coupled with this latter category of power supply system is the concept of navigation information that may be used to guide the vehicle for optimizing charge performance and to allow the vehicle to be self driving. This latter comprises not only the solo vehicle case but also the caravan case where vehicles travel in convoy and are able to access the sensor capabilities of the entire group. In a similar way, the collision avoidance sensors may be used to develop a performance record that, in combination with other information may be utilized to determine or infer how the vehicle has been used or driven over a period from a simple daily record to an entire lifetime record. Another source of charging is through the energy recovery systems accorded by the regenerative braking systems.

In summary, FIG. 9 illustrates that beyond the existing specifications for the on board diagnostics of today, future developments in vehicle technology will allow far more information to be collected and from those data may be inferred a highly detailed perspective of vehicle condition and its related value. The reduction of this information to graphical form may be done in any of a number of ways familiar to those skilled in the art and may be presented in any of a number of formats, from a simplified form for the neophyte buyer, renter or lessee to a sophisticated highly analytical form for the skilled professional. The information may be transferred to automatic fault diagnostic equipment that provides an expert system tool to aid in repair or service and may provide statistical error guidance to reduce fault finding efforts.

According to the foregoing embodiments, a vehicle diagnostic system and a method therefor are obtained. The vehicle diagnostic system and the method thereof are adapted for accessing to retrieve DTCs, designated data, additional information, parameters related to the status of the vehicle components being diagnosed from the OBD-II interface. The retrieved information is then processed by a processing logic, and then obtaining a vehicle health diagnostic report related to the vehicle components. In the vehicle health diagnostic report, in addition to displaying a status of health information for the vehicle sub-systems as either “Pass” or “Fail”, additional information and suggestions related to the vehicle components are also provided.

The vehicle diagnostic system has the following advantages:

1. In the vehicle health diagnostic report, in addition to displaying a status of health information for the vehicle sub-systems as either “Pass” or “Fail”, additional information and suggestions related to the vehicle components are also provided; and

2. The present invention provides a vehicle diagnostic system and a method therefor. The vehicle diagnostic system and the method therefor are adapted for accessing to retrieve DTCs, designated data, additional information, parameters related to the status of the vehicle components being diagnosed from the OBD-II interface. The retrieved information is then processed by a processing logic, and then obtaining a vehicle health diagnostic report related to the vehicle components.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized vehicular grading system useful in association with a vehicular diagnostic and reporting system (“VDRS”) associated with a vehicle under test (“VUT”), the grading method comprising:
receiving a plurality of vehicular component statuses from a VDRS of a VUT;
computing a corresponding plurality of scores from the plurality of vehicular component statuses, wherein the plurality of scores are computed utilizing stored statistical vehicular data associated with a plurality of vehicles similar to the VUT, and wherein the plurality of scores represent an overall condition of the VUT relative to the plurality of similar vehicles; and
generating a vehicular health report incorporating the plurality of scores.

2. The method of claim 1 wherein the plurality of vehicular component statuses include at least one of power plant status including the status of transmission train components, energy delivery status, brake and/or regeneration status, cabin environmental control status, instrumentation status and the status of other vehicle attributes.

3. The method of claim 1 further comprising utilizing the vehicular health report to provide an objective recommendation for at least one of a purchase decision, a rental decision, a lending decision, and a repair versus replacement decision.

4. The method of claim 1 wherein the VDRS is an OBD-II system with an OBD-II system interface, and wherein the plurality of vehicular component statuses include diagnostic trouble codes (DTC), designated data, additional information, and parameters compatible with the OBD-II system interface.

5. The method of claim 1 further comprising retrieving the statistical vehicular data from at least one database.

6. The method of claim 1 wherein the vehicular health diagnostic report includes at least one of a table and a graph.

7. The method of claim 1 further comprising updating the stored statistical vehicular data with the plurality of vehicular component statuses associated with the VUT.

8. A computerized vehicular grader useful in association with a vehicular diagnostic and reporting system (“VDRS”) associated with a vehicle under test (“VUT”), the vehicular grader comprising:
a vehicular interface configured to receive a plurality of vehicular component statuses from a VDRS of a VUT;
a processor configured to compute a corresponding plurality of scores from the plurality of vehicular component statuses, wherein the plurality of scores are computed utilizing stored statistical vehicular data associated with a plurality of vehicles similar to the VUT, and wherein the plurality of scores represent an overall condition of the VUT relative to the plurality of similar vehicles, and wherein the processor is further configured to generate a vehicular health report incorporating the plurality of scores; and
an interface configured to provide the vehicular health report to a user.

9. The vehicular grader of claim 8 wherein the plurality of vehicular component statuses include at least one of power plant status including the status of transmission train components, energy delivery status, brake and/or regeneration status, cabin environmental control status, instrumentation status and the status of other vehicle attributes.

10. The vehicular grader of claim 8 wherein the processor is further configured to utilize the vehicular health report to provide an objective recommendation for at least one of a purchase decision, a rental decision, a lending decision, and a repair versus replacement decision.

11. The vehicular grader of claim 8 wherein the VDRS is an OBD-II system with an OBD-II system interface, and wherein the plurality of vehicular component statuses include diagnostic trouble codes (DTC), designated data, additional information, and parameters compatible with the OBD-II system interface.

12. The vehicular grader of claim 8 further configured to retrieve the statistical vehicular data from at least one database.

13. The vehicular grader of claim 8 wherein the vehicular health diagnostic report includes at least one of a table and a graph.

14. The vehicular grader of claim 8 further configured to update the stored statistical vehicular data with the plurality of vehicular component statuses associated with the VUT.
